(19) United States
(12) Patent Application Publication
(10) Pub. No.: US 2025/0319750 A1
(43) Pub. Date: Oct. 16, 2025

(54) ACOUSTICALLY INSULATING GLAZED ASSEMBLY COMPRISING A VISCOELASTIC DAMPING LAYER

(71) Applicant: SAINT-GOBAIN GLASS FRANCE, COURBEVOIE (FR)

(72) Inventors: Gérald MERCIER, COURBEVOIE (FR); Francisco Javier CEDANO SERRANO, AUBERVILLIERS (FR); Choung-Houng LAI, WORCESTER, MA (US); Nicky CHAN, WORCESTER, MA (US)

(21) Appl. No.: 18/688,554

(22) PCT Filed: Sep. 2, 2022
(86) PCT No.: PCT/EP2022/074513

§ 371 Date: Sep. 5, 2024

(30) Foreign Application Priority Data
Sep. 2, 2021 (FR) 2109187

(51) Int. Cl. B60J 1/00; B32B 17/10; B60R 13/08

(52) U.S. Cl. CPC B60J 1/001; B32B 17/10036; B32B 17/10165; B32B 17/10743; B60R 13/0815; B32B 2250/03; B32B 2250/40; B32B 2307/102; B32B 2605/00

(57) ABSTRACT

The present invention relates to a glazed assembly for a vehicle, the glazed assembly comprising a first glass sheet and a second glass sheet superimposed, a first viscoelastic damping layer for the sound attenuation of the vehicle, the first damping layer being formed by a material comprising at least one acrylic polymer, at least one tackifier, and at least one plasticizer, the first damping layer being arranged between the first glass sheet and the second glass sheet and being in direct contact with the first glass sheet.

### FIELD OF THE INVENTION

The present invention relates to a glazed element comprising a viscoelastic damping layer for the sound attenuation of a motor vehicle, as well as a method for manufacturing such a glazed element. In particular, the glazed element may be an open side glazing of a motor vehicle.

### STATE OF THE ART

It is known to use a tempered glass glazing as open side glazing of a motor vehicle. However, such a glazing has a significant transmission of air noise caused by the turbulences of an air flow on the glazing, during the movement of the vehicle.

For this purpose, document EP2608958 describes a side glazing comprising a laminated glazed assembly. The laminated glazed assembly comprises two superposed glass sheets and an intermediate layer. The intermediate layer comprises two outer layers made of superposed PVB, and an inner layer made of PVB arranged between the two outer layers, the inner layer having acoustic damping properties higher than the two outer layers. Such a glazed element has higher sound attenuation properties than those of a glazing formed by a monolithic tempered glass.

However, the manufacture of a glazing comprising one or more PVB layers may prove to be complex. For example, the adhesion of a PVB layer to a glass sheet requires treatment in an autoclave. In addition, a glazed assembly comprising PVB layers has a thickness that can be greater than the thickness allowed by a rabbet of the door of a vehicle. Finally, a laminated glazing can have a lower mechanical strength than a tempered glazing.

### OVERVIEW OF THE INVENTION

One aim of the invention is to propose a solution for increasing the sound attenuation of a glazed assembly of a vehicle, in particular of a side window of a vehicle, while limiting the complexity of its manufacture.

This aim is achieved in the context of the present invention by virtue of a glazed assembly for a vehicle, the glazed assembly comprising a first glass sheet and a second glass sheet superimposed, the glazed assembly comprising a first viscoelastic damping layer for the sound attenuation of the vehicle, the first damping layer being formed by a material comprising:
at least one acrylic polymer,
at least one tackifier, and
at least one plasticizer,
   wherein the first damping layer is arranged between the first glass sheet and the second glass sheet and is in direct contact with the first glass sheet.

The present invention is advantageously completed by the following features, taken individually or in any of their technically possible combinations:
the material has a glass transition temperature of between −70° C. and 10° C. inclusive, in particular between −55° C. and 10° C. inclusive, in particular between −45° C. and 5° C., in particular between −45° C. and 0° C. and preferentially between −40° C. and −20° C.
the material has a mass fraction of the acrylic polymer(s) in the first layer of between 0.21 and 0.62, in particular between 0.21 and 0.51, and preferentially between 0.21 and 0.35,
the material has a mass fraction of the tackifier(s) in the first layer of between 0.17 and 0.60, in particular between 0.22 and 0.35, and preferentially between 0.22 and 0.26,
the material has a mass fraction of the plasticizer(s) in the first layer between 0.07 and 0.43, in particular between 0.12 and 0.31, and preferentially between 0.16 and 0.26,
the tackifier comprises a hydrogenated resin, and preferentially a hydrogenated rosin resin,
the acrylic polymer(s) are formed from monomers selected from the group formed by methyl acrylate, methyl methacrylate, ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, pentyl acrylate, pentyl methacrylate, isoamyl acrylate, isoamyl methacrylate, hexyl acrylate, hexyl methacrylate, cyclohexyl acrylate, cyclohexyl methacrylate, octyl acrylate, octyl methacrylate, isooctyl acrylate, isooctyl methacrylate, nonyl acrylate, nonyl methacrylate, isononyl methacrylate, isobornyl methacrylate, decyl acrylate, decyl methacrylate, dodecyl acrylate, dodecyl methacrylate, tridecyl acrylate, tridecyl methacrylate, hexadecyl acrylate, hexadecyl methacrylate, octadecyl acrylate, octadecyl methacrylate, 2-ethylhexyl acrylate, 2-ethylhexyl methacrylate, vinyl formate, vinyl acetate, vinyl propionate, 2-hydroxyethyl acrylate, hydroxyethyl methacrylate, 2-hydroxypropyl acrylate, 2-hydroxypropyl methacrylate, acrylic acid, styrene and acrylonitrile,
the first damping layer has a thickness e between 5 μm and 500 μm, in particular between 30 μm and 100 μm and preferentially between 40 μm and 70 μm,
the material comprises a first acrylic polymer having a first glass transition temperature, T_{g1}, and a second polymer having a second glass transition temperature T_{g2}, higher than T_{g1}, the difference between the second glass transition temperature, T_{g2} and between the first glass transition temperature T_{g1} is preferentially greater than 10° C., and preferentially greater than 20° C.,
the first damping layer is in direct contact with the second glass sheet,
the glazed assembly comprises a second damping layer, the second damping layer being arranged between the first damping layer and the second glass sheet, the second damping layer being in direct contact with the second glass sheet,
the first damping layer is formed by a first material having a first loss factor η₁, the second damping layer is formed by a second material having a second loss factor η₂, the glazed assembly comprising an intermediate layer, the intermediate layer being arranged between the first damping layer and the second damping layer, the intermediate layer being formed by a third material having a third loss factor η₃, the third loss factor η₃ being strictly less than the first loss factor η₁ and strictly less than the second loss factor η₂,
the first material has a first Young's modulus E₁ and a real part of the first Young's modulus E′₁, the second material has a second Young's modulus E₂ and a real part of the second Young's modulus E′₂, the third material has a third Young's modulus E₃ and a real part of the third Young's modulus E′₃, the real part of the third Young's modulus E′₃ being strictly greater than the real part of the first Young's modulus E₁ and strictly greater than the real part of the second Young's modulus E₂,
the first glass sheet has a first thickness e₁, the second glass sheet has a second thickness e₂, the first thickness e₁ being strictly greater than the second thickness e₂, the first thickness e₁ being preferentially between 1 mm and 5 mm inclusive, the second thickness e₂ being preferentially between 0.5 mm and 5 mm excluded,
the material of the first damping layer has a maximum loss factor η₁ₘₐₓ in a frequency range between 1 kHz and 10 KHz,
the maximum loss factor η₁ₘₐₓ is greater than 1, and preferentially greater than 3.5,
the glazed assembly is a lateral glazed assembly of a vehicle, preferentially an open side glazed assembly of a vehicle.

Another aspect of the invention is a method for manufacturing a glazed assembly according to one embodiment of the invention, the method comprising:
a) a step of depositing a liquid composition on a first glass sheet, the composition comprising a latex, a tackifier and a plasticizer, the latex comprising an emulsion, the emulsion comprising an aqueous continuous phase and a dispersed phase, the dispersed phase comprising at least one acrylic polymer,
b) a step of drying the composition on the first glass sheet, so as to form a first damping layer.

Advantageously, the depositing of the liquid composition on the first glass sheet is implemented by a bar coating method.

### DESCRIPTION OF THE FIGURES

Other features, purposes and advantages of the invention will emerge from the following description, which is purely illustrative and non-limiting, and which must be read in conjunction with the appended drawings in which:

FIG. 1 schematically shows a side glazing according to one embodiment of the invention,

FIG. 2 schematically shows a detail of a cross-section of a glazed assembly according to one embodiment of the invention, wherein the glazed assembly comprises a single damping layer,

FIG. 3 schematically shows a method of manufacturing a glazed assembly according to one embodiment of the invention,

FIG. 4 shows a loss factor of a material of a glazed assembly according to one embodiment of the invention, for different mass fractions of tackifier and plasticizer of the first layer,

FIG. 5 shows a real part of a shear modulus of a material of a glazed assembly according to one embodiment of the invention, for different mass fractions of tackifier and plasticizer of the first layer,

FIG. 6 schematically shows a cross-section of a glazed assembly according to one embodiment of the invention, comprising two interlayers,

FIG. 7 shows the sound attenuation of a glazed element according to one embodiment of the invention and the sound attenuation of a known glazed element, depending on the frequency of an incident wave at each glazed element.

In all the figures, similar elements are marked with identical references.

### Definitions

“Loss factor η” of a material means, when the material has a complex Young's modulus, the ratio between the imaginary part E″ of the Young's modulus of the material and the real part E of the Young's modulus of the material. The loss factor η of a material is defined by international standard ISO 18437-2:2005 (Mechanical vibration and shock—Characterization of the dynamic mechanical properties of visco-elastic materials—Part 2: Resonance method, part 3.2). Preferentially, the loss factor η can be defined for a predetermined frequency. “A material has a first loss factor greater than a value” means that the material has a first loss factor greater than the value for at least one chosen frequency in the audible frequency range, that is in a frequency range extending between 20 Hz and 20 KHz, inclusive, and preferentially between 20 Hz and 10 KHz, inclusive, at 20° C.

“The real part E′ of the Young's modulus of a material is greater than a value” means that the real part E′ of the Young's modulus of the material is greater than the value of the real part E′ of the Young's modulus of the material for at least one chosen frequency in the audible frequency range, that is in a frequency range extending between 20 Hz and 20 kHz, inclusive, and preferentially between 20 Hz and 10 KHz, inclusive, at 20° C.

The real part E and the imaginary part E″ of the Young's modulus can be defined for a predetermined temperature. In the present application, “the real part E′ of the Young's modulus of a material is greater to a value means that the material has a real part E of the Young's modulus greater than the value at 20° C. In the present case, “a material has a first loss factor η greater than a value” means that the material has a first loss factor η greater than the value at 20° C.

Shear modulus G can be linked, in particular for an isotropic material, to the Young's modulus E by the relationship G=E/2(1+v), wherein v is the Poisson's ratio of the material.

A dynamic characterization of a material can be carried out on a visco-analyzer of the Metravib visco-analyzer type, under the following measurement conditions. A sinusoidal load is applied to the material. A measurement sample made of the material to be measured consists of two rectangular parallelepipeds, each parallelepiped having a thickness of 3.31 mm, a width of 10.38 mm and a height of 6.44 mm. Each parallelepiped made of the material is also referred to as a shear “test specimen”. The excitation is implemented with a dynamic amplitude of 5 μm around the rest position, covering the frequency range comprised between 1 Hz and 700 Hz, and covering a temperature range comprised between −90° C. and +60° C.

The visco-analyzer makes it possible to subject each test specimen (each sample) to deformations under precise temperature and frequency conditions, and to measure the displacements of the test specimen, the forces applied to the test specimen and their phase shift, which makes it possible to measure rheological quantities characterizing the material of the test specimen.

The use of measurements makes it possible especially to calculate the Young's modulus E of the material, and particularly the real part E′ of the Young's modulus and the imaginary part E″ of the Young's modulus of the material, and thus to calculate the tangent of the loss angle (or loss factor) η (also referred to as tan δ).

A value of the real part E′ of the Young's modulus and/or a loss factor η of a material are measured without the material being pre-stressed.

The term “light transmission factor” means the factor defined in the NF EN 410 standard.

The term “haze factor” the ratio between the intensity of the light diffused by passing through the glazed element (diffuse fraction or I_{d}) at an angle greater than 2.5° and between the intensity of the light transmitted through the glazed element (I_{L}). The haze factor may be measured by spectroscopy techniques. The integration of the intensity over the whole of the visible range (from 380 nm to 780 nm) makes it possible to determine the normal transmission T_{L} and diffuse transmission T_{d}. Such a measurement may also be obtained using a hazemeter. A glazing is considered transparent if its haze factor is less than 10%, in particular less than 5% and preferentially less than 1%. The hazemeter may be a Haze-Gard® device sold by BYK-Gardner.

The term “lightness factor” means the ratio defined by the following formula:

$$\begin{matrix}[ Math . 1 ] & \\ {f}_{c} = \frac{{I}_{c} - {I}_{r}}{{I}_{c} + {I}_{c}} & ( 1 )\end{matrix}$$

where I_{c} is the intensity of light after passing through a glazing not having been diffused, and Iᵣ is the intensity of light after passing through the glazing having been diffused at a small angle, preferentially an angle equal to 15°. The lightness factor may be measured by spectroscopy techniques. The integration of the intensity over the whole of the visible range (from 380 nm to 780 nm) makes it possible to determine the normal transmission T_{L} and diffuse transmission T_{d}. Such a measurement may also be obtained using a hazemeter. It is considered that a glazing is transparent if its lightness factor is greater than 90% and preferentially greater than 95%.

A glass transition temperature T_{g} of a material, preferably of the first damping layer, can be measured by Differential Scanning calorimetry (DSC) analysis. The glass transition temperature may be determined using the midpoint method as described in ASTM-D-3418 for differential scanning calorimetry. The measurement apparatus used by the applicant is the Discovery DSC model from TA Instruments.

Preferably, a glass transition temperature T_{g} is determined by dynamic mechanical analysis (DMA) or dynamic mechanical spectrometry. The value of T_{g} is determined by plotting an isofrequency curve of the loss factor as a function of the temperature of the material. The temperature at which the value of the loss factor is maximum is equal to the glass transition temperature T_{g}. The glass transition temperature depends on the excitation frequency of the material. In the present application, “glass transition temperature” means the glass transition temperature measured at a frequency of 1 Hz by DMA.

The term “mass fraction” of a first element in a second element means the ratio of the mass of the first element to the mass of the second element.

### DETAILED DESCRIPTION OF THE INVENTION

### General Architecture of the Glazed Assembly

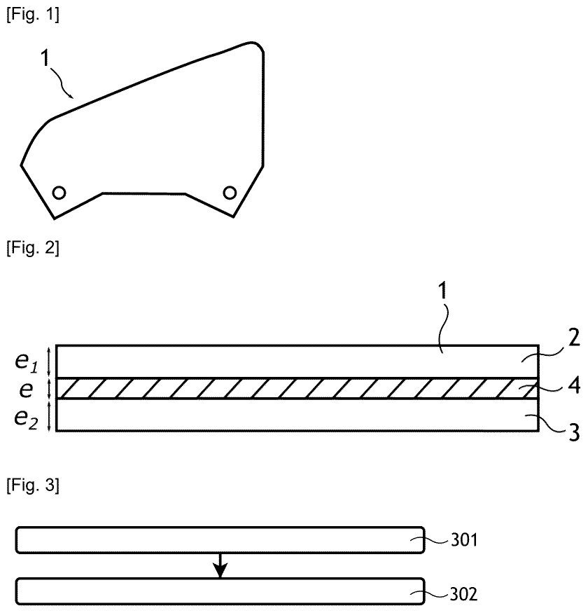

With reference to FIG. 1 and to FIG. 2, a glazed assembly 1 comprises a first glass sheet 2 and a second glass sheet 3 superimposed. The first glass sheet 2 and/or the second glass sheet 3 may be formed by a mineral glass or an organic glass.

The glazed assembly 1 may be chosen from a windshield, a rear window, and a lateral glazed assembly of a vehicle. The vehicle may be an automobile, a train, and/or an aircraft. With reference to FIG. 1, the glazed assembly 1 is preferably an open lateral glazed assembly of a vehicle.

With reference to FIG. 2, the glazed assembly 1 comprises a first viscoelastic damping layer 4 for the sound attenuation of the vehicle. The first layer 4 is formed by a material comprising at least one acrylic polymer, at least one tackifier, and at least one plasticizer. The material of the first damping layer has a maximum loss factor η₁ₘₐₓ in a frequency range between 1 KHz and 10 KHz, The maximum loss factor η₁ₘₐₓ may be greater than 1, and preferentially greater than 3.5.

The first damping layer 4 is arranged between the first glass sheet 2 and the second glass sheet 3 and is in direct contact with the first glass sheet 2. Thus, the acoustically insulating glazed assembly is both simpler to manufacture than known glazed assemblies having comparable sound attenuation properties, for example a glazed assembly comprising a layer of PVB (polyvinyl butyral), and has both light transmission, haze and lightness properties suitable for use in a vehicle.

Indeed, the inventors have discovered that a material formed at least by an acrylic polymer, by a tackifier and by a plasticizer may both have sound attenuation properties and may form, when the material is in direct contact with the first glass sheet 2, a transparent interface allowing the glazed element to have a light transmission factor, a haze factor and a lightness factor suitable for a vehicle glazing. Preferably, a light transmission factor of the glazed element 1 is greater than 90%. Preferably, a haze factor of the glazed element 1 is less than 1%. Preferably, a lightness factor of the glazed element 1 is greater than 99%.

The first damping layer 4 has a thickness e₁ between 5 μm and 500 μm, in particular between 30 μm and 100 μm and preferentially between 40 μm and 70 μm. Thus, the glazed assembly has sound attenuation properties while using a reduced quantity of raw material to manufacture the first layer 4 facing the known glazed elements.

### First Viscoelastic Damping Layer 4

As previously defined, the first layer 4 is formed by a material comprising at least one acrylic polymer, at least one tackifier, and at least one plasticizer.

The material may have a glass transition temperature of between −55° C. and 10° C. inclusive, in particular between −45° C. and 5° C., and preferentially between −30° C. and −5° C. Thus, at 20° C., a maximum loss factor of the material may be within an audible frequency range.

### Acrylic Polymer(s)

The acrylic polymer(s) may be formed from monomers selected from the group formed by methyl acrylate, methyl methacrylate, ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, pentyl acrylate, pentyl methacrylate, isoamyl acrylate, isoamyl methacrylate, hexyl acrylate, hexyl methacrylate, cyclohexyl acrylate, cyclohexyl methacrylate, octyl acrylate, octyl methacrylate, isooctyl acrylate, isooctyl methacrylate, nonyl acrylate, nonyl methacrylate, isononyl methacrylate, isobornyl methacrylate, decyl acrylate, decyl methacrylate, dodecyl acrylate, dodecyl methacrylate, tridecyl acrylate, tridecyl methacrylate, hexadecyl acrylate, hexadecyl methacrylate, octadecyl acrylate, octadecyl methacrylate, 2-ethylhexyl acrylate, 2-ethylhexyl methacrylate, vinyl formate, vinyl acetate, vinyl propionate, 2-hydroxyethyl acrylate, hydroxyethyl methacrylate, 2-hydroxypropyl acrylate, 2-hydroxypropyl methacrylate, acrylic acid, styrene and acrylonitrile.

The acrylic polymer(s) may be copolymers, formed from at least two monomers chosen from the group formed by the monomers defined previously.

Preferably, the first damping layer 4 can comprise two different acrylic polymers. One of the two polymers may be 2-ethylhexyl acrylate (2-EHA) and/or butylacrylate (BA). Preferably, one of the two polymers is 2-ethylhexyl acrylate (2-EHA) and the other of the two polymers is butylacrylate (BA). The mass ratio between 2-ethylhexyl acrylate (2-EHA) and butylacrylate (BA) may be between 2 and 4, and is preferentially equal to 3.

Other commercial latexes comprising an acrylic polymer can be used to form the first layer 4. It is for example possible to use the Arkema® Encor 4028, Arkema® Encor 4517, or Alberdingk® A_B75070 latexes.

The material may comprise another polymer which is not an acrylic polymer. Such another polymer may be formed from at least one monomer selected from styrene and methyl methacrylate.

The material may comprise a first acrylic polymer having a first glass transition temperature T_{g1} and a second polymer, acrylic or non-acrylic, having a second glass transition temperature T_{g2}, greater than T_{g1}. The difference between the second glass transition temperature T_{g2} and between the first glass transition temperature T_{g1} is preferentially greater than 10° C., and preferentially greater than 20° C. Thus, it is possible to increase the glass transition temperature of the material with regard to the glass transition temperature of a material obtained only with the first acrylic polymer. Indeed, the glass transition temperature obtained only with the first acrylic polymer may be too small to have a maximum damping of the material in an audible frequency range.

The polymer(s) may form an interpenetrating polymer network (IPN). The interpenetrating polymer network can be manufactured from a latex deposited on the first glass sheet. The term “latex” means a dispersion of polymeric particles in water or in an aqueous solvent. The latex may comprise polymeric particles having a core-shell structure. The core may be formed by an interpenetrating polymer network (IPN) having a glass transition temperature (T_{g}) comprised between −50° C. and −30° C., preferably between −45° C. and −35° C., and the shell can be formed of a polymer having a glass transition temperature that is small enough to allow the coalescence of the particles after drying. The glass transition temperature of the shell may be less than that of the core, and may preferably be less than −50° C., and more preferentially less than −60° C. The core formed of an interpenetrating polymer network can be obtained by two sequential polymerizations. The IPN thus comprises a third crosslinked polymer and a fourth polymer, which may be crosslinked or non-crosslinked. If the fourth polymer is non-crosslinked, the IPN is referred to as a “semi-interpenetrated polymer” network. The fourth polymer may be linear or branched.

### Tackifier

The tackifier is suitable for allowing the bonding of the first glass sheet 2 to another layer in direct contact with the first layer 4, preferentially with the second glass layer 3.

The tackifier may comprise a hydrogenated resin, and preferentially a hydrogenated rosin resin, The hydrogenated resin may comprise a glyceric ester of wood resin, preferably abietic acid. The hydrogenated resin may comprise a hydrogenated rosin ester (for example a resin of the brand Arkawa® KEY-311 or KE 100).

### Plasticizer

The plasticizer is adapted to increase the plastic properties of the first layer 4. The plasticizer may comprise at least one element selected from citrate, adipate, glycol and triethylene glycol derivative. The citrate may be acetyl-tributyl citrate. Adipate may be triethylene glycol bis (2-ethylhexanoate) (for example, sold under the name WVC 3800 of Celanese®).

### Method for Manufacturing the Glazed Element 1

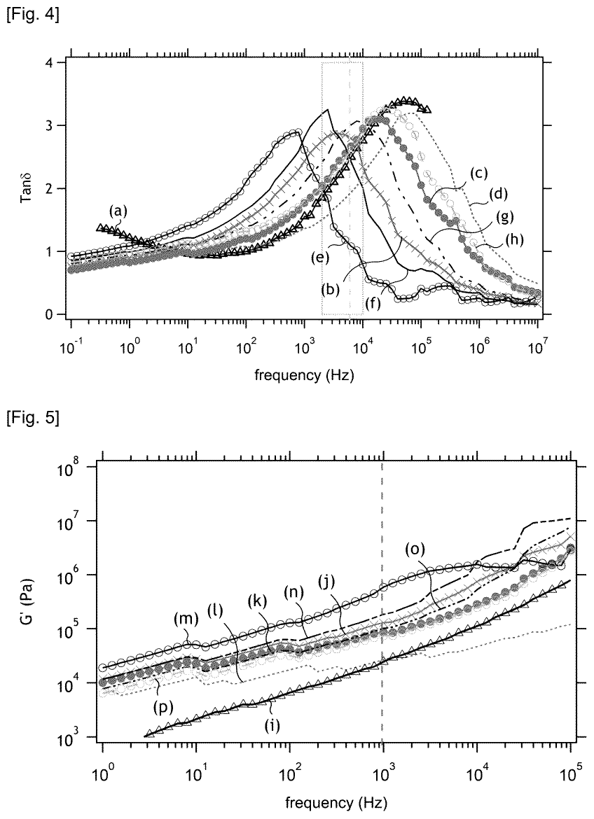

Referring to FIG. 3, another aspect of the invention is a method of manufacturing a glazed assembly 1 according to one embodiment of the invention. The method comprises a step 301 of depositing a liquid composition on the first glass sheet 2. The composition comprises a latex, a tackifier and a plasticizer. The latex comprises an emulsion. The emulsion comprises an aqueous continuous phase and a dispersed phase. The dispersed phase comprising at least one acrylic polymer. The composition can be a dilution of the latex, the tackifier and the plasticizer in an aqueous phase.

The method comprises a step of drying 302 the composition on the first glass sheet 2, so as to form a first damping layer 4. Thus, it is possible to form the first damping layer 4 directly on the first glass sheet 2, while forming a transparent interface, having optical properties suitable for a glazed assembly of a vehicle.

The step 301 of depositing the composition on the first glass sheet may be implemented by a bar coating method (also called a film-drawing method).

The method then comprises a rolling step in which the second glass sheet 8 is arranged. Finally, the method may comprise a step in which the glazed assembly is evacuated, for example to a pressure of less than 300 Pa.

Thus, it is possible to manufacture a glazed assembly having a transmission factor of greater than 90%, a haze factor of less than 1%, and a lightness factor of greater than 99%.

### Adjustment of the Acoustic Properties of the Glazed Element 1

The material has a mass fraction of the acrylic polymer(s) in the first layer of between 0.21 and 0.62, in particular between 0.21 and 0.51, and preferentially between 0.21 and 0.35. Thus, the material of the first layer 4 has a loss factor tan δ greater than 1.

Known materials for sound attenuation comprising an acrylic polymer have a frequency fₚ for which a value of the loss factor tan δ of the material of the first layer 4 is greater than 50 kHz. This frequency is not included in the audible frequency spectrum, which reduces the sound attenuation properties.

The material may have a mass fraction of the plasticizer(s) in the first layer 4 between 0.07 and 0.43, in particular between 0.12 and 0.31, and preferentially between 0.16 and 0.26. Thus, the frequency fₚ for which the value of the loss factor tan δ of the material of the first layer 4 is maximum in the audible frequency spectrum while increasing the value of the loss factor tan δ with regard to the known materials.

Indeed, the inventors have discovered that, for a predetermined concentration of acrylic polymer(s), the frequency fₚ for which the loss factor is maximum varies in the same direction as the plasticizer mass fraction in the first layer 4. The inventors thus discovered the range of plasticizer mass fraction in the first layer 4 for which the frequency fₚ is contained within the audible frequency spectrum. In addition, the value of the loss factor tan δ of the material of the first layer 4 varies in the same direction as the plasticizer mass fraction in the first layer 4.

The material may have a tackifier mass fraction in the first layer of between 0.17 and 0.60, in particular between 0.22 and 0.35, and preferentially between 0.22 and 0.26, Thus, the frequency fₚ for which the value of the loss factor tan δ of the material of the first layer 4 is maximum in the audible frequency spectrum.

Indeed, the inventors have discovered that, for a predetermined concentration of acrylic polymer(s), the frequency fₚ for which the loss factor is maximum varies in the opposite direction as the tackifier mass fraction in the first layer. The inventors thus discovered the range of tackifier mass fraction in the first layer 4 for which the frequency fₚ is contained within the audible frequency spectrum. In addition, the value of the loss factor tan δ of the material of the first layer 4 varies with little dependency on the tackifier mass fraction in the first layer 4.

With reference to FIG. 4, curve (a) shows a loss factor of a layer different from the first layer 4, manufactured from an adhesive which does not make it possible to implement a transparent interface between a glass sheet and the layer, unlike the interface obtained in the embodiments of the invention. Curve (b) shows a loss factor of the first layer 4, the acrylic polymer mass fraction being equal to 0.58, the plasticizer mass fraction in the first layer 4 being equal to 0.08 and the tackifier mass fraction in the first layer 4 being equal to 0.34. Curve (c) shows a loss factor of the first layer 4, the acrylic polymer mass fraction being equal to 0.55, the plasticizer mass fraction in the first layer 4 being equal to 0.12 and the tackifier mass fraction in the first layer 4 being equal to 0.32. Curve (d) shows a loss factor of the first layer 4, the acrylic polymer mass fraction being equal to 0.53, the plasticizer mass fraction in the first layer 4 being equal to 0.16 and the tackifier mass fraction in the first layer 4 being equal to 0.31. Curve (e) shows a loss factor of the first layer 4, the acrylic polymer mass fraction being equal to 0.49, the plasticizer mass fraction in the first layer 4 being equal to 0.09 and the tackifier mass fraction in the first layer 4 being equal to 0.43. Curve (f) shows a loss factor of the first layer 4, the acrylic polymer mass fraction being equal to 0.48, the plasticizer mass fraction in the first layer 4 being equal to 0.10 and the tackifier mass fraction in the first layer 4 being equal to 0.42. Curve (g) shows a loss factor of the first layer 4, the acrylic polymer mass fraction being equal to 0.46, the plasticizer mass fraction in the first layer 4 being equal to 0.14 and the tackifier mass fraction in the first layer 4 being equal to 0.41. Curve (h) shows a loss factor of the first layer 4, the acrylic polymer mass fraction being equal to 0.42, the plasticizer mass fraction in the first layer 4 being equal to 0.09 and the tackifier mass fraction in the first layer 4 being equal to 0.49.

With reference to FIG. 5, curve (i) shows a real part G′ of the shear modulus of a layer different from the first layer 4, manufactured from an adhesive which does not make it possible to implement a transparent interface between a glass sheet and the layer obtained after drying the adhesive, unlike the interface obtained in the embodiments of the invention. Curve (j) shows the real part G′ of the shear modulus of the first layer 4, the acrylic polymer mass fraction being equal to 0.58, the plasticizer mass fraction in the first layer 4 being equal to 0.08 and the tackifier mass fraction in the first layer 4 being equal to 0.34. Curve (k) shows the real part G′ of the shear modulus of the first layer 4, the acrylic polymer mass fraction being equal to 0.55, the plasticizer mass fraction in the first layer 4 being equal to 0.12 and the tackifier mass fraction in the first layer 4 being equal to 0.32. Curve (I) shows the real part G′ of the shear modulus of the first layer 4, the acrylic polymer mass fraction being equal to 0.53, the plasticizer mass fraction in the first layer 4 being equal to 0.16 and the tackifier mass fraction in the first layer 4 being equal to 0.31. Curve (m) shows the real part G′ of the shear modulus of the first layer 4, the acrylic polymer mass fraction being equal to 0.49, the plasticizer mass fraction in the first layer 4 being equal to 0.09 and the tackifier mass fraction in the first layer 4 being equal to 0.43. Curve (n) shows the real part G′ of the shear modulus of the first layer 4, the acrylic polymer mass fraction being equal to 0.48, the plasticizer mass fraction in the first layer 4 being equal to 0.10 and the tackifier mass fraction in the first layer 4 being equal to 0.42. Curve (o) shows the real part G′ of the shear modulus of the first layer 4, the acrylic polymer mass fraction being equal to 0.46, the plasticizer mass fraction in the first layer 4 being equal to 0.14 and the tackifier mass fraction in the first layer 4 being equal to 0.41. Curve (p) shows the real part G′ of the shear modulus of the first layer 4, the acrylic polymer mass fraction being equal to 0.42, the plasticizer mass fraction in the first layer 4 being equal to 0.09 and the tackifier mass fraction in the first layer 4 being equal to 0.49.

Advantageously, the material has an acrylic polymer mass fraction in the first layer 4 of between 0.21 and 0.62, a plasticizer mass fraction in the first layer 4 of between 0.07 and 0.43 and a tackifier mass fraction in the first layer of between 0.17 and 0.60.

Advantageously, the material has an acrylic polymer mass fraction in the first layer 4 of between 0.21 and 0.51, a plasticizer mass fraction in the first layer 4 of between 0.12 and 0.31 and a tackifier mass fraction in the first layer of between 0.22 and 0.35.

Advantageously, the material has an acrylic polymer mass fraction in the first layer 4 of between 0.21 and 0.35, a plasticizer mass fraction in the first layer 4 of between 0.16 and 0.26 and a tackifier mass fraction in the first layer of between 0.22 and 0.26.

Advantageously, the material has an acrylic polymer mass fraction in the first layer 4 of between 0.21 and 0.62, a plasticizer mass fraction in the first layer 4 of between 0.12 and 0.31 and a tackifier mass fraction in the first layer of between 0.22 and 0.35.

Advantageously, the material has an acrylic polymer mass fraction in the first layer 4 of between 0.21 and 0.62, a plasticizer mass fraction in the first layer 4 of between 0.16 and 0.26 and a tackifier mass fraction in the first layer of between 0.22 and 0.26.

### Arrangement of the Damping Layer(s)

With reference to FIG. 1, the glazed assembly 1 may comprise a single damping layer, the only damping layer being the first layer 4. The first damping layer 4 can then be in direct contact with the second glass sheet 3. Thus, it is possible to manufacture an acoustically insulating glazed assembly 1 by reducing the thickness of the glazed assembly 1 with respect to the thickness of the known acoustically insulating glazed assemblies.

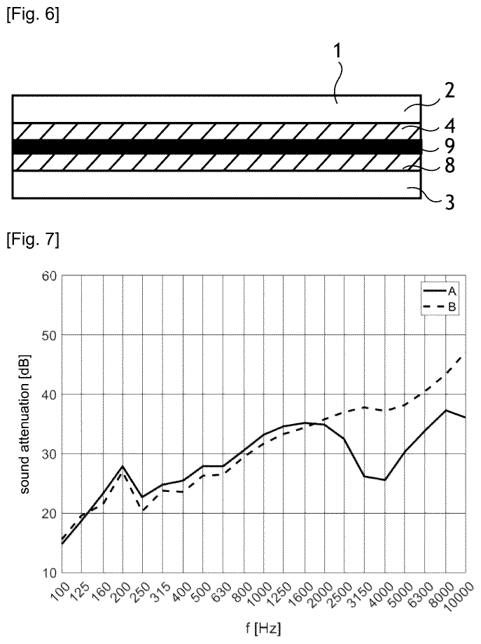

With reference to FIG. 6, the glazed assembly 1 can comprise a plurality of viscoelastic damping layers. The damping layers are arranged between the first glass sheet 2 and the second glass sheet 3. The glazed assembly 1 may comprise a first damping layer 4 and a second damping layer 8. The second damping layer 8 is arranged between the first damping layer 4 and the second glass sheet 3. The second damping layer 8 is in direct contact with the second glass sheet 3. The second damping layer 8 may be formed by a material comprising at least one acrylic polymer, at least one tackifier, and at least one plasticizer. The material of the second layer 8 may be a suitable material for the first layer 4.

The first damping layer 4 is formed by a first material having a first loss factor η₁. The second damping layer 8 is formed by a second material having a second loss factor η₂. The first loss factor η₁ and the second loss factor η₂ are preferentially greater than 1.

The first layer 4 may be in direct contact with the second layer 8. As a variant and with reference to FIG. 5, the glazed assembly 1 may comprise an intermediate layer 9. The intermediate layer 9 may be arranged between the first layer 4 and the second layer 8. The intermediate layer 9 may be formed by a third material having a third loss factor η₃. The third loss factor η₃ may be strictly less than the first loss factor and strictly less than the second loss factor η₂.

The first material has a first Young's modulus E₁ and a real part of the first Young's modulus E′₁. The second material has a second Young's modulus E₂ and a real part of the second Young's modulus E₂. The third material has a third Young's modulus E₃ and a real part of the third Young's modulus E′₃. The real part of the third Young's modulus E's may be strictly greater than the real part of the first Young's modulus E′₁ and strictly greater than the real part of the second Young's modulus E₂.

### Glass Sheets

The first glass sheet 2 has a first thickness e₁. The second glass sheet 3 has a second thickness e₂. The first thickness e₁ may be strictly greater than the second thickness e₂. Thus, it is possible, for a predetermined thickness of the glazed assembly 1, to increase the sound attenuation of the glazed assembly.

The first thickness e₁ may be between 1 mm and 5 mm inclusive. The second thickness e₂ may be between 0.5 mm and 5 mm inclusive.

### Acoustic Characterization of the Glazed Assembly 1

FIG. 7 shows the sound attenuation of the glazed assembly 1 subjected to air noise produced according to standard NF EN 10140. The curve formed by broken lines shows the sound attenuation of a monolithic laminated glazing unit, having a thickness equal to 3.85 mm. The curve formed by a continuous line shows a glazed assembly 1, comprising a first layer comprising two types of acrylic polymers, formed from 2-ethylhexyl acrylate and isobutyl acrylate. The thickness e₁ of the first layer 4 is equal to 30 μm. The first glass sheet 2 and the second glass sheet each have a thickness equal to 1.6 mm. In a frequency range between 2 kHz and 10 KHz, the sound attenuation of the glazed assembly 1 can be 12 decibels greater than the sound attenuation of the glazed assembly formed by a glazing made of monolithic tempered glass.

1. A glazed assembly (1) for a vehicle, the glazed assembly (1) comprising a first glass sheet (2) and a second glass sheet (3) superimposed, the glazed assembly (1) comprising a first viscoelastic damping layer (4) for the sound attenuation of the vehicle, characterized in that the first damping layer (4) is formed by a material comprising:
at least one acrylic polymer,
at least one tackifier, and
at least one plasticizer,
the first damping layer (4) being arranged between the first glass sheet (2) and the second glass sheet (3) and being in direct contact with the first glass sheet (2).

2. The glazed assembly according to claim 1, wherein the material has a glass transition temperature of between −70° C. and 10° C. inclusive, in particular between −45° C. and 0° C. and preferentially between −40° C. and −20° C.

3. The glazed assembly (1) according to claim 1 or 2, wherein the material has an acrylic polymer mass fraction in the first layer (4) of between 0.21 and 0.62, in particular between 0.21 and 0.51, and preferentially between 0.21 and 0.35.

4. The glazed assembly (1) according to one of the claims 1 to 3, wherein the material has a tackifier mass fraction in the first damping layer (4) of between 0.17 and 0.60, in particular between 0.22 and 0.35, and preferentially between 0.22 and 0.26.

5. The glazed assembly (1) according to one of the claims 1 to 4, wherein the material has a plasticizer mass fraction in the first damping layer (4) of between 0.07 and 0.43, in particular between 0.12 and 0.31, and preferentially between 0.16 and 0.26.

6. The glazed assembly (1) according to one of claims 1 to 5, wherein the tackifier comprises a hydrogenated resin, and preferentially a hydrogenated rosin resin.

7. The glazed assembly (1) according to one of claims 1 to 6, wherein the acrylic polymer(s) are formed from monomers selected from the group formed by methyl acrylate, methyl methacrylate, ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, pentyl acrylate, pentyl methacrylate, isoamyl acrylate, isoamyl methacrylate, hexyl acrylate, hexyl methacrylate, cyclohexyl acrylate, cyclohexyl methacrylate, octyl acrylate, octyl methacrylate, isooctyl acrylate, isooctyl methacrylate, nonyl acrylate, nonyl methacrylate, isononyl methacrylate, isobornyl methacrylate, decyl acrylate, decyl methacrylate, dodecyl acrylate, dodecyl methacrylate, tridecyl acrylate, tridecyl methacrylate, hexadecyl acrylate, hexadecyl methacrylate, octadecyl acrylate, octadecyl methacrylate, 2-ethylhexyl acrylate, 2-ethylhexyl methacrylate, vinyl formate, vinyl acetate, vinyl propionate, 2-hydroxyethyl acrylate, hydroxyethyl methacrylate, 2-hydroxypropyl acrylate, 2-hydroxypropyl methacrylate, acrylic acid, styrene and acrylonitrile,

8. The glazed assembly (1) according to one of claims 1 to 7, wherein the first damping layer (4) has a thickness e between 5 μm and 500 μm, in particular between 30 μm and 100 μm.

9. The glazed assembly (1) according to one of claims 1 to 8, wherein the material comprises a first acrylic polymer having a first glass transition temperature, T_{g1}, and a second polymer having a second glass transition temperature T_{g2}, higher than T_{g1}, the difference between the second glass transition temperature, T_{g2} and between the first glass transition temperature T_{g1} is preferentially greater than 10° C., and preferentially greater than 20° C.

10. The glazed assembly (1) according to one of claims 1 to 9, wherein the first damping layer (4) is in direct contact with the second glass sheet (3).

11. The glazed assembly (1) according to one of claims 1 to 10, comprising a second damping layer (8), the second damping layer (8) being arranged between the first damping layer (4) and the second glass sheet (3), the second damping layer (8) being in direct contact with the second glass sheet (3).

12. The glazed assembly (1) according to the preceding claim, wherein the first damping layer (4) is formed by a first material having a first loss factor η₁, the second damping layer (8) is formed by a second material having a second loss factor η₂, the glazed assembly (1) comprising an intermediate layer (9), the intermediate layer (9) being arranged between the first damping layer (4) and the second damping layer (8), the intermediate layer (9) being formed by a third material having a third loss factor η₃, the third loss factor η₃ being strictly less than the first loss factor and strictly less than the second loss factor η₂,

13. The glazed assembly (1) according to one of the claims 1 to 12, wherein the first glass sheet (2) has a first thickness e₁, the second glass sheet (3) has a second thickness e₂, the first thickness e₁ being strictly greater than the second thickness e₂, the first thickness e₁ being preferentially between 1 mm and 5 mm inclusive, the second thickness e₂ being preferentially between 0.5 mm and 5 mm excluded.

14. The glazed assembly (1) according to one of claims 1 to 13, wherein the material of the first damping layer (4) has a maximum loss factor η₁ₘₐₓ in a frequency range between 1 KHz and 10 KHz, the maximum loss factor η₁ₘₐₓ being in particular greater than 1, and preferentially greater than 3.5.

15. The glazed assembly (1) according to one of claims 1 to 14, the glazed assembly being an open side glazed assembly of a vehicle.

16. A method for manufacturing a glazed assembly (1) according to one of claims 1 to 15, the method comprising:
a) a step of depositing a liquid composition on a first glass sheet (2), the composition comprising a latex, a tackifier and a plasticizer, the latex comprising an emulsion, the emulsion comprising an aqueous continuous phase and a dispersed phase, the dispersed phase comprising at least one acrylic polymer,
b) a step of drying the composition on the first glass sheet (2), so as to form a first damping layer (4).
